(19) United States
(12) Patent Application Publication
(10) Pub. No.: US 2012/0293991 A1
(43) Pub. Date: Nov. 22, 2012

(54) LED LAMP AND LED HOLDER CAP THEREOF

(76) Inventor: Chiu-Min LIN, Taoyuan County (TW)

(21) Appl. No.: 13/108,350

(22) Filed: May 16, 2011

(51) Int. Cl. F21S 4/00; F21V 21/00

(52) U.S. Cl. 362/225; 362/217.14

(57) ABSTRACT

An LED lamp has an LED lamp board mounted in a lamp tube and two LED holder caps respectively mounted around two ends of the lamp tube. Each LED holder cap has a cap body, two pins and two parallel holding walls. One end of each pin is mounted in the circular board. One of the holding walls is conductive and connected with the pins. When the LED holder caps are respectively mounted around two ends of the lamp tube, the holding walls of each LED holder cap holds one end of the LED lamp board, and the conducting holding wall is electrically connected with a corresponding power contact of the LED lamp board so that the pins are respectively electrically connected with the power contacts. Accordingly, the problem of soldering wires with the LED lamp board and the pins of the LED holder caps can be eliminated.

### BACKGROUND OF THE INVENTION

1. Field of the Invention

The present invention relates to an LED lamp and LED holder cap, and more particularly to an LED lamp directly and electrically connected with a lamp board inside the LED lamp and an LED holder cap for the LED lamp.

2. Description of the Related Art

LED lamps are advantageous in energy conservation and environmental protection because of low power consumption and high light-emitting efficiency. As a result, LED lamps come into play to gradually replace conventional lamps recently. To avoid replacing a lamp socket due to incompatibility with an inserted LED lamp, the LED lamp is designed to be identical to the conventional incandescent bulb or fluorescent bulb in terms of size and electrical connection structure. One type of common LED lamps that is similar to conventional fluorescent lamps in size emerges to replace the conventional fluorescent lamps, and such an LED lamp has a lamp tube, an LED lamp board and two LED holder caps. The lamp tube is circular tubular and has a non-transparent half tube and a transparent half tube. The LED lamp board is mounted in an inner wall of the lamp tube. A light exit surface of the LED lamp board faces the transparent half tube. Power pins on the LED holder caps mounted on two ends of the lamp tube are respectively connected to power contacts of the LED lamp board through wires to supply the power from the lamp socket to the LED lamp board for lighting.

Each LED holder cap of the foregoing LED lamp has two pins mounted through the LED holder cap. One end of each pin inside the LED holder cap is soldered with a wire. However, drawbacks such as cold solder or insufficient soldering strength may occur at solder joints and easily lead to loose contact between the LED holder cap and the connected power wire, thereby lowering the durability of the conventional LED lamps.

### SUMMARY OF THE INVENTION

An objective of the present invention is to provide an LED lamp directly and electrically connected with a lamp board inside the LED lamp and an LED holder cap thereof.

To achieve the foregoing objective, the LED lamp has a hollow lamp tube and an LED lamp board.

The hollow lamp tube has two openings formed through two ends of the lamp tube and being opposite to each other.

The LED lamp board has a circuit board, multiple LED light sources and two power contacts. The circuit board is mounted in the lamp tube. The LED light sources are mounted on the circuit board. The power contacts are respectively mounted on two ends of the circuit board adjacent to the respective openings of the lamp tube.

The LED holder caps are respectively mounted around the two ends of the lamp tube, and each LED holder cap has a cap body, two pins and two holding walls. The cap body has a circular board and an annular wall. The annular wall is formed on and protrudes from a perimeter of the circular board. One end of each pin is mounted in the circular board. The holding walls are parallelly formed on an inner wall of the circular board. One of the holding walls is conductive and connected with the pins. One end of the circuit board of the lamp board is mounted between the holding walls of one of the LED holder caps so that the conducting holding wall is in contact with a corresponding power contact of the lamp board.

With the two parallel holding walls formed inside the LED holder cap of the lamp tube, the conducting holding walls can be directly connected with the power contacts of the circuit board of the lamp board after the LED holder caps are mounted around both ends of the hollow lamp tube, thereby avoiding the use of additional wires connected with the power contacts and the pins of the circuit board, cold solder, insufficient soldering strength and lower durability of the LED lamp. Accordingly, a more stable and durable LED lamp in accordance with the present invention can be provided.

An LED holder cap of the foregoing LED lamp has a cap body, two pins and two holding walls. The cap body has a circular board and an annular wall. The annular wall is formed on and protrudes from a perimeter of the circular board. One end of each pin is mounted in the circular board. The holding walls are parallelly formed on an inner wall of the circular board. One of the holding walls is conductive and connected with the pins.

After the LED holder caps are mounted on the lamp tube, the two parallel holding walls formed on an inner wall of each LED holder cap sandwich one side of the circuit board of the LED lamp board so that the conducting holding wall directly contacts a corresponding power contact of the circuit board and two pins are electrically connected with the power contact of the circuit board through the conductive holding wall.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an LED lamp in accordance with the present invention;

FIG. 2 is an exploded perspective view of the LED lamp in FIG. 1;

FIG. 3 is an enlarged cross-sectional top view of the LED lamp in FIG. 1;

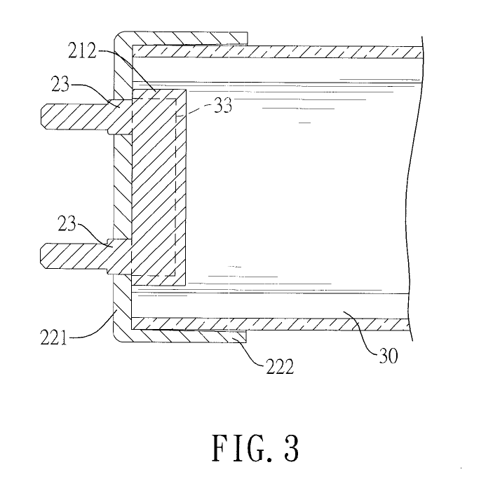

FIG. 4 is an enlarged end view in partial section of the LED lamp in FIG. 1; and

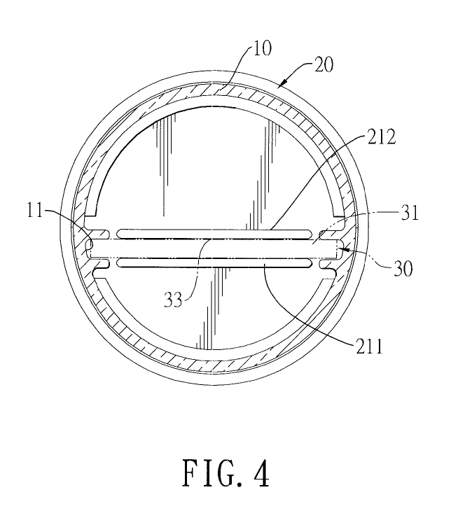

FIG. 5 is an enlarged cross sectional side view of the LED lamp in FIG. 1.

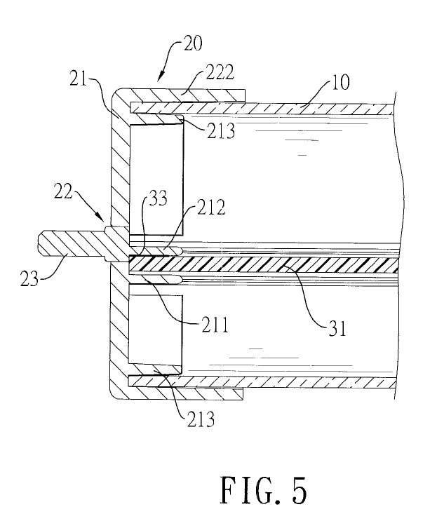

### DETAILED DESCRIPTION OF THE INVENTION

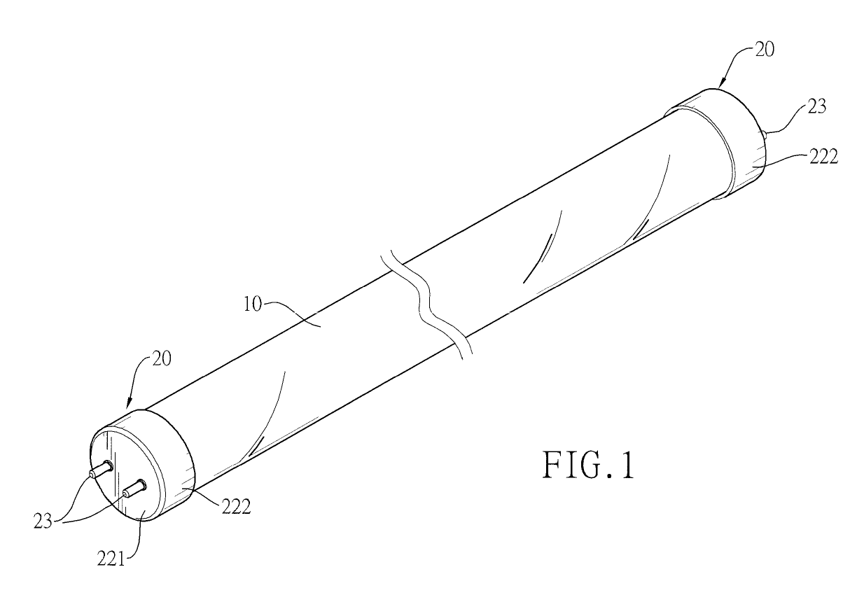

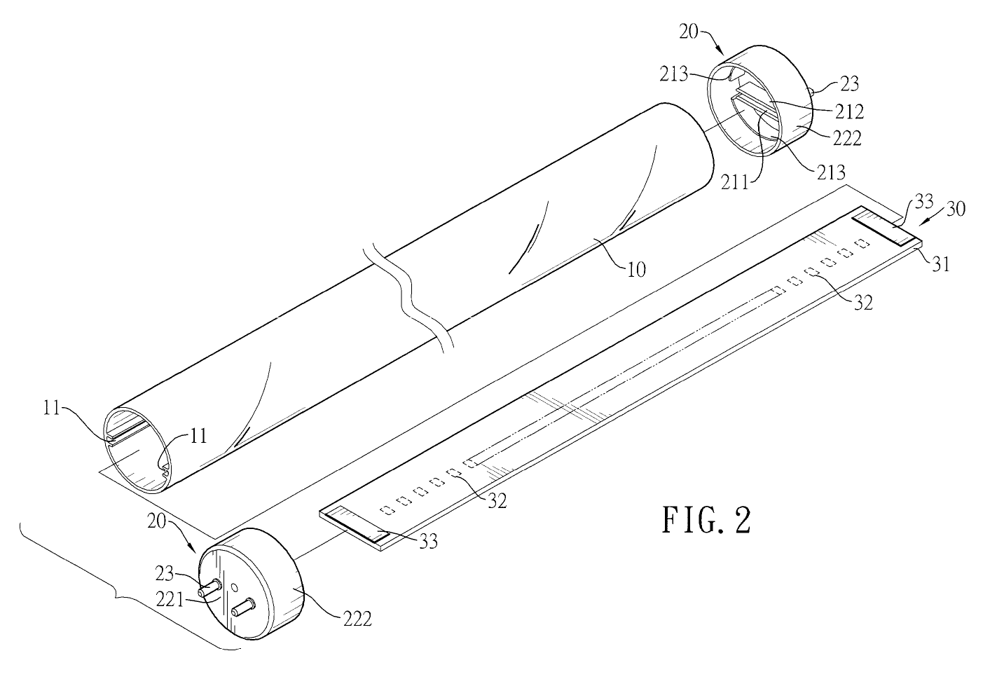

With reference to FIGS. 1 and 2, an LED lamp in accordance with the present invention has a hollow lamp tube 10, an LED lamp board 30 and two LED holder caps 20.

The lamp tube 10 has two openings formed through two ends of the lamp tube 10 and being opposite to each other. In the present embodiment, two sliding channels 11 are diametrically opposed and formed in an inner wall of the lamp tube 10.

The LED lamp board 30 has a circuit board 31, multiple LED light sources 32 and two power contacts 33. The circuit board 31 is mounted in the lamp tube 10 and is held in the two sliding channels 11. The LED light sources 32 are mounted on the circuit board 31. The power contacts 33 are respectively mounted on two ends of the circuit board 31 adjacent to the openings of the lamp tube 10. In the present embodiment, the LED light sources 32 are mounted on a bottom of the circuit board 31, and each power contact 33 is mounted on a top of one end of the circuit board 31 adjacent to a corresponding opening of the lamp tube 10.

The two LED holder caps 20 are respectively mounted around the two ends of the lamp tube 10 to respectively cover the two openings of the lamp tube 10. Each LED holder cap 20 has a cap body 22, two pins 23 and two holding walls 211, 212. The cap body 22 has a circular board 221 and an annular wall 222. The annular wall 222 is formed around and protrudes from a perimeter of the circular board 221. One end of each pin 23 is mounted in the circular board 221. The two holding walls 211, 212 are parallelly formed on an inner wall of the circular board 221. One of the holding walls 212 is conductive and is connected with the pins 23. One end of the circuit board 31 of the lamp board 30 is mounted between the holding walls 211, 212 of one of the LED holder caps 20 so that the conductive holding wall 212 is in contact with a corresponding power contact 33 of the lamp board 30.

When each LED holder cap 20 is tightly mounted around one end of the lamp tube 10 to cover a corresponding opening of the lamp tube 10, the circular board 221 further has two arced walls 213. The arced walls 213 are diametrically opposed and circularly formed on an inner wall and alongside the perimeter of the circular board 31, and each arced wall 213 and an inner wall of the annular wall 222 define a space therebetween for one end of the lamp tube 10 to be tightly mounted in the spaces inside the LED holder cap 20.

With the two parallel holding walls 211, 212 formed inside the LED holder cap 20 of the lamp tube 10, the conductive holding walls 212 can be directly connected with the power contacts 33 of the circuit board 31 of the lamp board 30 after the LED holder caps 20 are mounted around both ends of the hollow lamp tube 10, thereby avoiding the problems of the use of additional wires connected with the power contacts 33 and the pins 23 of the circuit board 31, cold solder, insufficient soldering strength and lower durability of the LED lamp. Accordingly, a stable and durable LED lamp can be provided.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. An LED lamp comprising:
a hollow lamp tube having two openings formed through two ends of the lamp tube and being opposite to each other; and
an LED lamp board having:
a circuit board mounted in the lamp tube;
multiple LED light sources mounted on the circuit board; and
two power contacts respectively mounted on two ends of the circuit board adjacent to the openings of the lamp tube; and
two LED holder caps respectively mounted around the two ends of the lamp tube, and each LED holder cap having:
a cap body having:
a circular board; and
an annular wall formed around and protruding from a perimeter of the circular board;
two pins, wherein one end of each pin is mounted in the circular board; and
two holding walls parallelly formed on an inner wall of the circular board, wherein one of the holding walls is conductive and is connected with the pins, and one end of the circuit board of the lamp board is mounted between the holding walls of one of the LED holder caps so that the conducting holding wall is in contact with a corresponding power contact of the lamp board.

2. The LED lamp as claimed in claim 1, wherein each LED holder cap further has two arced walls diametrically opposed and circularly formed on an inner wall and alongside the perimeter of the circular board and each arced wall and an inner wall of the annular wall define a space therebetween for one end of the lamp tube to be tightly mounted in the space inside the LED holder cap.

3. The LED lamp as claimed in claim 1, wherein the lamp tube further has two sliding channels diametrically opposed and formed in an inner wall of the lamp tube, and the circuit board is mounted in the lamp tube through the two sliding channels.

4. The LED lamp as claimed in claim 2, wherein the lamp tube further has two sliding channels diametrically opposed and formed in an inner wall of the lamp tube, and the circuit board is mounted in the lamp tube through the two sliding channels.

5. The LED lamp as claimed in claim 3, wherein the LED light sources are mounted on a bottom of the circuit board, and each power contact is mounted on a top of one end of the circuit board adjacent to a corresponding opening of the lamp tube.

6. The LED lamp as claimed in claim 4, wherein the LED light sources are mounted on a bottom of the circuit board, and each power contact is mounted on a top of one end of the circuit board adjacent to a corresponding opening of the lamp tube.

7. An LED holder cap for an LED lamp comprising:
a cap body having:
a circular board; and
an annular wall formed on and protruding from a perimeter of the circular board;
two pins, wherein one end of each pin is mounted in the circular board; and
two holding walls parallelly formed on an inner wall of the circular board, wherein one of the holding walls is conductive and connected with the pins.

8. The LED holder cap as claimed in claim 7, further comprising two arced walls diametrically opposed and circularly formed on an inner wall and alongside the perimeter of the circular board, wherein each arced wall and an inner wall of the annular wall define a space therebetween for one end of the lamp tube to be tightly mounted in the space inside the LED holder cap.
